(19) United States
(12) Patent Application Publication
(10) Pub. No.: US 2008/0011375 A1
(43) Pub. Date: Jan. 17, 2008

(54) COMBINATION CAP AND PLUG

(75) Inventor: Houssam Soubjaki, Huntington Woods, MI (US)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/457,245

(22) Filed: Jul. 13, 2006

(51) Int. Cl. F16L 55/10

(52) U.S. Cl. 138/89

(57) ABSTRACT

A combination cap and plug member that includes a first end, a second end, and an outer surface portion between the first end and the second end and configured to be received in an opening of a hollow member. The cap and plug member further includes a first tapered cavity and a second tapered cavity. The first tapered cavity includes an opening at least partially defined in the first end. The first tapered cavity defines an inner dimension that increases toward the first end, and the first tapered cavity is configured to receive a member. The second tapered cavity includes an opening at least partially defined in the second end. The second tapered cavity defines an inner dimension that increases toward the second end, and the second tapered cavity is configured to receive a member.

### BACKGROUND

The present invention relates to a member that can be used as either a cap or a plug.

When hollow members, such as pipes, tubes, fittings, containers, and the like are stored, transported, or not in use, it can be desirable to prevent foreign matter such as dirt, debris, dust, etc. from entering the hollow portion of the member. Typically, either a cap that is sized to fit over an opening of the member or a plug that is sized to fit in the opening of the member is utilized to inhibit debris from entering the hollow member through the opening.

### SUMMARY

Typically, caps and plugs are provided in a variety of sizes to accommodate different size openings. It is desirable to create a single cap and plug member that can be used with a wide range of opening sizes.

In one embodiment, the invention provides a combination cap and plug member that includes a first end, a second end, and an outer surface portion between the first end and the second end and configured to be received in an opening of a hollow member. The cap and plug member further includes a first tapered cavity and a second tapered cavity. The first tapered cavity includes an opening at least partially defined in the first end. The first tapered cavity defines an inner dimension that increases toward the first end and the first tapered cavity is configured to receive a member. The second tapered cavity includes an opening at least partially defined in the second end. The second tapered cavity defines an inner dimension that increases toward the second end and the second tapered cavity is configured to receive a member.

In another embodiment the invention provides a combination cap and plug member that includes a tapered outermost surface portion that extends from the first end substantially to the second end and is configured to be received in an opening of a hollow member.

In yet another embodiment the invention provides a combination cap and plug member that includes a first end, a second end, and an outer surface portion between the first end and the second end and configured to be received in an opening of a hollow member. The cap and plug member further includes a tapered cavity having an opening at least partially defined in the first end. The tapered cavity defines an inner dimension that increases toward the first end. The first tapered cavity is configured to receive a member and the tapered cavity defines one of a frustoconical and a conical volume.

Other aspects of the invention will become apparent by consideration of the detailed description and accompanying drawings.

### BRIEF DESCRIPTION OF THE DRAWINGS

FIG. 1 is a perspective view of a cap and plug member embodying the present invention.

FIG. 2 is a perspective view of the cap and plug member of FIG. 1 taken from an opposite end.

FIG. 3 is a side view of the cap and plug member of FIG. 1.

FIG. 4 is a cross-sectional view of the cap and plug member of FIG. 1 taken along line 4-4 of FIG. 3.

FIGS. 5a-5e are cross-sectional views of the cap and plug member of FIG. 1 illustrating the cap and plug member being used with different size members.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

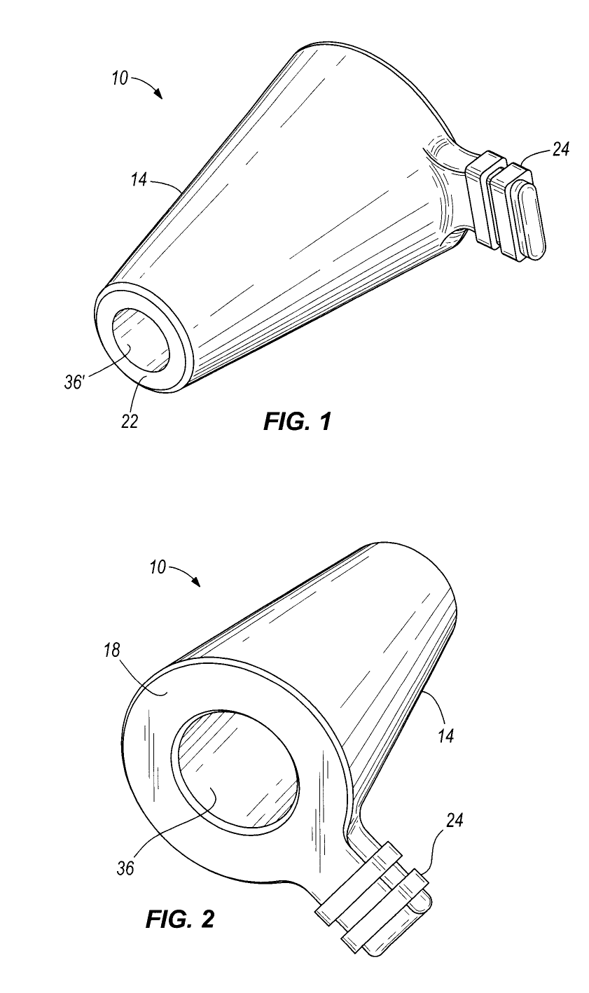

FIGS. 1 and 2 illustrate a combination cap and plug member 10 that includes a body portion 14 having a first end 18 and a second end 22. The cap and plug member 10 further includes a tab 24 that extends from the body portion 14 adjacent the first end 18, the purpose of which will be discussed below.

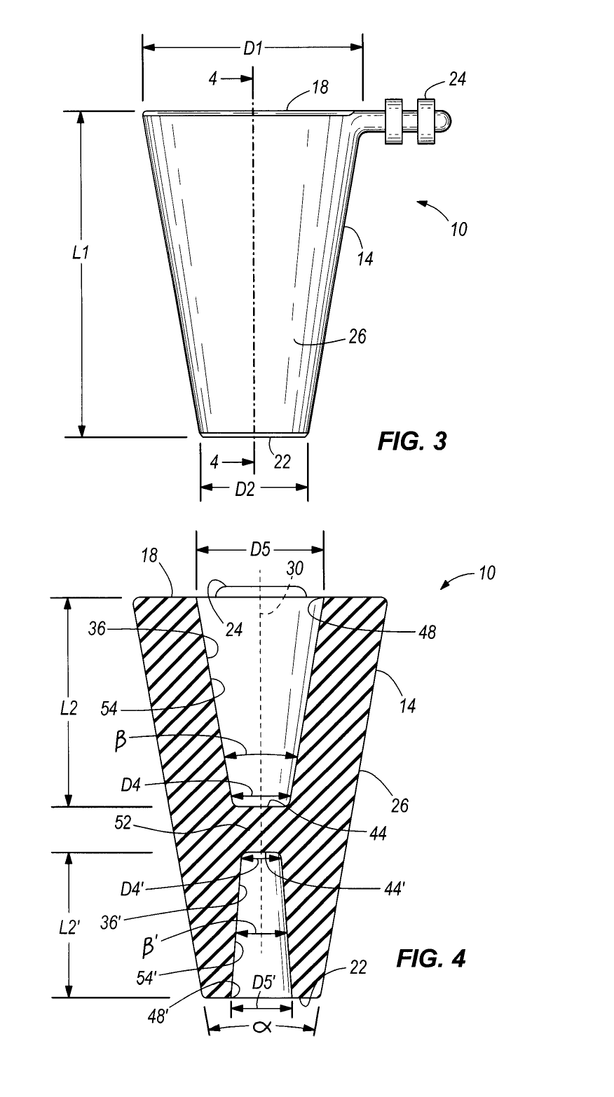

Referring to FIGS. 3 and 4, the body portion has a length L1 that extends from the first end 18 to the second end 22. The first end 18 defines an outer dimension D1 and the second end 22 defines an outer dimension D2. In the illustrated construction, the outer dimension D1 of the first end 18 is larger than the outer dimension D2 of the second end 22. In other constructions, the outer dimensions D1 of the first end 18 may equal the outer dimension D2 of the second end 22. While the illustrated first and second ends 18 and 22 of the body portion 14 are circular, such that the dimensions D1 and D2 are diameters of the first and second ends 18 and 22 respectively, in other constructions, the first and second ends can take other suitable shapes, such as triangular, square, rectangular, pentagonal, hexagonal, etc.

In one construction, the outer diameter D1 of the first end 18 is approximately 20 mm and the outer diameter D2 of the second end 22 is approximately 10 mm such that the ratio of the outer diameters D1/D2 is approximately 2:1. In other constructions, the outer diameters D1 and D2 can be any suitable length and the ratio D1/D2 can be any suitable ratio.

The body portion 14 includes an outer surface 26. In the illustrated construction, the outer surface 26 of the body portion 14 is the outermost surface of the cap and plug member 10. In other constructions, a shroud, cover, and the like can be connected to the body portion 14 near the first end 18 and extend toward the second end 22 and spaced from the outer surface 26 to define an annular opening between the outer surface 26 and the shroud or cover.

With continued reference to FIGS. 3 and 4, a central axis 30 extends longitudinally through the center of the body portion 14. The outer surface 26 of the illustrated cap and plug member 10 is tapered with respect to the central axis 30 as shown in FIG. 4. The taper angle α can be any suitable angle and in the illustrated construction the angle α is approximately 20 degrees. In other constructions, the angle α can range from about 0 degrees to about 60 degrees. In yet other constructions, the angle α can range from about 0 degrees to about 40 degrees. It should be understood that in constructions where the taper angle α is 0 degrees, the outer surface 26 is parallel to the central axis 30 and the body portion 14 forms a cylinder.

Referring to FIGS. 3 and 4, in the illustrated construction, the outer surface 26 is tapered along substantially the entire length L1 of the body 14 from the second end 22 to the first end 18. In other constructions, the taper of the outer surface 26 may not extend all the way to the first end 18. In such constructions, the outer surface 26 may include a portion near the first end 18 that has no taper (i.e., a taper angle α of 0 degrees) or that has surface features to facilitate gripping the cap and plug member 10 by the user.

In the illustrated construction, the taper of the outer surface 26 is constant, or does not change from the second end 22 to the first end 18. In other words, in the illustrated construction, the taper angle α equals 20 degrees generally along substantially the entire length L1 of the body portion 14. The constant taper of the angle α defines the frustoconical shape of the illustrated cap and plug member 10. It should be understood that the plug and cap member 10 may include features near the first end 18 to facilitate gripping or grasping the cap and plug member 10, such as the tab 24, while remaining generally frustoconical.

In other constructions, the taper angle α of the outer surface 26 may not be constant. For example, the outer surface 26 may include a first portion with a first taper angle and a second portion with a second taper angle that is less than or greater than the first taper angle.

In one construction, and as illustrated in FIGS. 1-4, the outer surface 26 is generally continuously sloped from the second end 22 to substantially the first end 18. Therefore, at any point on the outer surface 26 from the second end 22 to substantially the first end 18 there is no portion of the outer surface 26 that has steps, shoulders, or other geometry creating deviation from the generally continuous taper. It should be understood that the outer surface 26 may include a portion near the first end 18 with a slope that is not continuous, while the outer surface 26 is still generally continuously sloped from the second end 22 to the first end 18.

While in the illustrated construction the cap and plug member 10 is generally frustoconical, in other constructions, the cap and plug member can take other suitable shapes. For example, in other constructions the cap and plug member can be generally conical or can have three sides, such that the cap and plug member forms a pyramid or frusto-pyramid. In other constructions, the cap and plug member can have four or more sides and form any suitable shape.

Referring to FIG. 4, the cap and plug member 10 further includes a first tapered cavity 36 and a second tapered cavity 36′. Excluding dimensions, the first and second cavities 36 and 36′ are generally the same and like components of the second tapered cavity 36′ have been given the same reference number as the corresponding component of the first tapered cavity 36 with the addition of a prime symbol.

The first cavity 36 includes an innermost end 44 and an opening 48 that is opposite the innermost end 44. The second cavity 36′ includes an innermost end 44′ and an opening 48′ that is opposite the innermost end 44′. The opening 48 of the first cavity 36 is defined in the first end 18 of the body portion 14 and the opening 48′ of the second cavity 36′ is defined in the second end 22 of the body portion 14. The innermost ends 44 and 44′ of the respective first and second cavities 36 and 36′ are defined by a wall portion 52 of the cap and plug member 10. The wall portion 52 separates the first and second cavities 36 and 36′.

Referring to FIGS. 3 and 4, lengths L2 and L2′ of the respective first and second cavities 36 and 36′ are defined as the distance from the innermost ends 44, 44′ to the openings 48, 48′. In the illustrated construction, the length L2 of the first cavity 36 is about one-half, or 50 percent of the length L1 of the cap and plug member 10 and the length L2′ of the second cavity 36′ is about 35 percent of the length L1 of the cap and plug member 10. In other constructions, the lengths L2 and L2′ of the respective first and second cavities 36 and 36′ can range from about 25 percent to about 75 percent of the length L1 of the cap and plug member 10 such that the lengths L2 and L2′ total less than the length L1 of the cap and plug member 10 in order to allow adequate space for the wall portion 52 that separates the cavities 36 and 36′. In yet other constructions, the length L2 and L2′ of the first and second cavities 36 and 36′ can be any suitable length or percentage of the length L1 of the cap and plug member 10.

The first and second cavities 36 and 36′ are partially defined by respective cavity walls 54 and 54′ that extend from the innermost end 44, 44′ to the opening 48, 48′. The cavity walls 54 and 54′ of the respective first and second cavities 36 and 36′ define an inner dimension of the first and second cavities 36 and 36′. The walls 54 and 54′ of the cavities 36 and 36′ are tapered with respect to central axis 30 to define respective taper angles β and β′ such that the inner dimensions of the cavities 36 and 36′ are smallest at the innermost ends 44 and 44′, labeled D4 and D4′, and greatest at the openings 48 and 48′, labeled D5 and D5′. In one construction, the dimension D4′ is approximately 3 mm, D5′ approximately 4 mm, D4 approximately 4 mm, and D5 approximately 12 mm. In such a construction the ratio of D5 to D4′ is approximately 4:1. In other constructions, the maximum and minimum inner dimensions of the first and second cavities can be any suitable dimension. The ratio of D5 to D4′ defines a size range of members that can be inserted into the first and second cavities 36 and 36′, as will be discussed below.

As illustrated in FIG. 4, the taper angle β of the first cavity 36 is approximately 20 degrees and the taper angle β of the second cavity 36′ is approximately 10 degrees. In other constructions, the taper angles β and β′ of the first and second cavities 36 and 36′ can range from about 5 degrees to about 60 degrees. In yet other constructions, the taper angles β and β′ of the first and second cavities 36 and 36′ can be any suitable angle.

In the illustrated construction, the taper angles β and β′ of the first and second cavities 36 and 36′ are constant, or do not change from the innermost ends 44 and 44′ to the openings 48 and 48′. In other words, in the illustrated construction, the taper angle β of the first cavity 36 is approximately 20 degrees along the entire length L2 of the first cavity 36 and the taper angle β′ of the second cavity 36′ is approximately 10 degrees along the entire length L2′ of the second cavity 36′. In other constructions, the taper angles β and β′ of the cavities 36 and 36′ may not be constant. For example, the first cavity 36 may include a first portion with a first taper angle and a second portion with a second taper angle that is less than or greater than the first taper angle.

With continued reference to FIG. 4, the illustrated first and second cavities 36 and 36′ have a non-annular cross section generally along the entire length L2 and L2′ of the cavities 36 and 36′. Therefore, taking a cross section of the cavities 36 and 36′ generally at any point along the lengths L2 and L2′, perpendicular to the central axis 30, creates a cross section of the cavities 36 and 36′ that does not include an annulus (i.e., there are no members within the walls 54, 54′). The non-annular cross section and the constant taper of the angles β and β′ of the first and second cavities 36 and 36′ results in the first and second cavities 36 and 36′ having frustoconical volumes. In other constructions, the first and second cavities 36 and 36′ can have a conical volume or a combination of a conical and a frustoconical volume.

In one construction, the cavities 36 and 36′ are generally continuously sloped or tapered from the innermost ends 44 and 44′ to the openings 48 and 48′. Therefore, at any point from the innermost ends 44 and 44′ to the openings 48 and 48′ there is no portion of the cavity walls 54 and 54′ that has steps, shoulders, or other geometry creating deviation from the generally continuous taper.

While the illustrated cap and plug member 10 includes the first tapered cavity 36 and the second tapered cavity 36′, in other constructions the cap and plug member may include only a single tapered cavity having an opening in either end of the cap and plug member.

In one construction, the cap and plug member 10 is formed from a resilient material, such as rubber or other suitable materials. The resilient material allows the cap and plug member 10 to generally regain its original shape after the cap and plug member 10 has been deformed. The cap and plug member 10 can be formed using any suitable method such as an open/shut dye tool set-up for injection molding and the like.

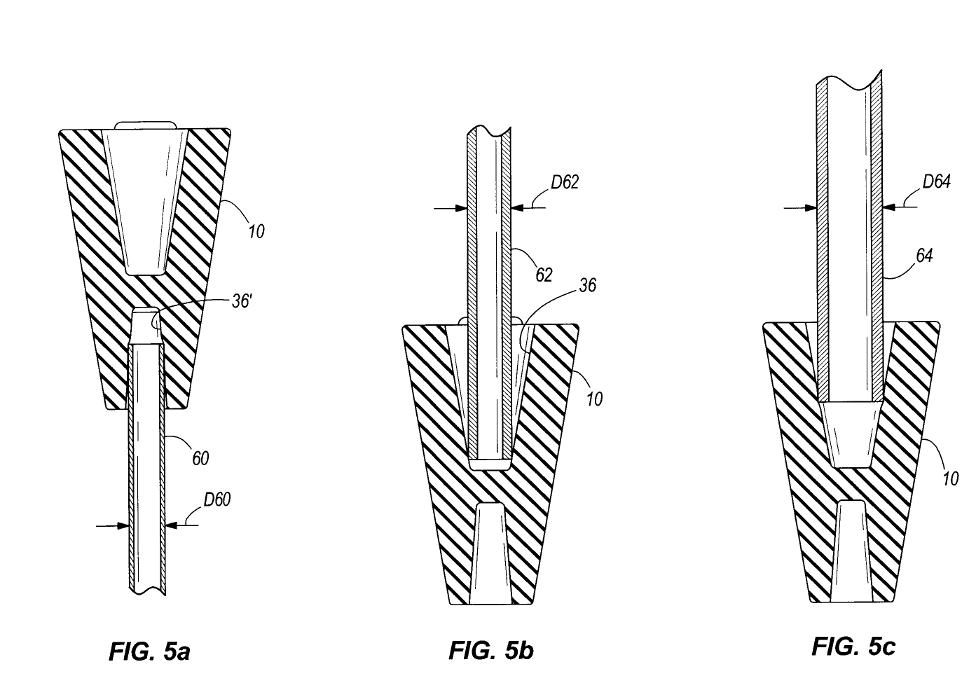

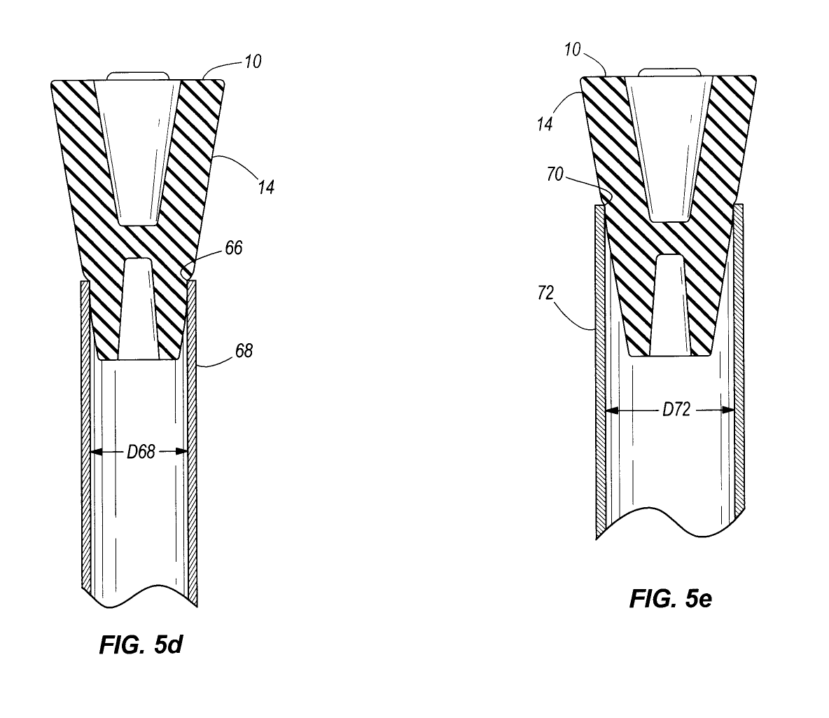

Referring to FIGS. 5a-5e, in operation, the cap and plug member 10 can be used as either a cap (FIGS. 5a-5c) or as a plug (FIGS. 5d-5e). Referring to FIGS. 4 and 5a, the second cavity 36′ receives a member 60 having an outer dimension D60. The second cavity 36′, with a minimum inner dimension of D4′ and a maximum inner dimension of D5′ can be used to cap a member with an outer dimension that ranges from about the minimum inner dimension D4′ of the second cavity 36′ to about the maximum inner dimension D5′ of the second cavity 36′.

Referring to FIGS. 4, 5b, and 5c, if the outer dimension of the member is greater than the largest inner dimension D5′ of the second cavity 36′, then the user can use the first cavity 36 to cap the member. For example, FIG. 5b illustrates the first cavity 36 being used to cap a member 62 having an outer dimension D62 that is greater than the smallest inner dimension D4 of the first cavity 36. The first cavity 36 can be used to cap a member if the outer dimension of the member ranges from about the minimum inner dimension D4 of the first cavity 36 to about the maximum inner dimension D5 of the first cavity 36. FIG. 5c illustrates the first cavity 36 being used to cap a member 64 having an outer dimension D64 that is between the outer dimension D62 of the member 62 of FIG. 5b and the largest inner dimension D5 of the first cavity 36.

Referring to FIGS. 4 and 5d, if an outer dimension of the member is larger than the largest inner dimension D5 of the first cavity 36, then the user can use the body portion 14 of the cap and plug member 10 to plug an opening 66 of a member 68 having an inner dimension D68. FIG. 5e illustrates the cap and plug member 10 of FIG. 3 being used to plug an opening 70 of a member 72 having an inner dimension D72 that is greater than the minimum outer dimension D2 of the body portion 14 and less than the maximum outer dimension D1 of the body portion 14.

Referring to FIGS. 3 and 4, in one construction the minimum outer dimension D2 of the body portion 14 is less than the maximum outer dimension D5 of the first cavity 36. For example, if the maximum inner dimension D5 of the first cavity 36 is 12 mm than the minimum outer dimension D2 of the body 14 can be 10 mm (i.e., a difference of 2 mm). In other constructions, the difference between the maximum outer dimension D5 of the first cavity 36 and the minimum outer dimension D2 of the body portion 14 can be any suitable difference. Such a configuration compensates for the wall thickness of the member and ensures that the combination cap and plug member 10 can be used as either a cap or plug for a substantially continuous size range of members. In yet other constructions, the minimum outer dimension D2 of the body portion 14 can be greater than or equal to the maximum outer dimension D5 of the first cavity 36.

For example, the cap and plug member 10 described above can be used as a cap for members with an outer dimension that ranges from about 3 mm to about 12 mm and the cap and plug member 10 can be used as a plug for members with an inner dimension that ranges from about 10 mm to about 20 mm. The maximum 12 mm dimension for use as a cap and the minimum 10 mm dimension for use as a plug allows for approximately a 2 mm wall thickness of the member while still allowing the cap and plug member to be used with a continuous size range of members (i.e., 3 mm outer dimension to 20 mm inner dimension). Of course, this is just one example of possible size ranges that the cap and plug member can accommodate and in other constructions the cap and plug member can be configured to cap or plug any suitable size range.

Referring to FIG. 3, the tab 24 can be utilized by the user to remove the cap and plug member 10 from the members that are capped or plugged. When the user desires to remove the cap and plug member 10 from the member that is capped or plugged, the user can grasp and pull on the tab 24 to remove the cap and plug member 10. Of course, the tab 24 illustrated in FIG. 3 is just one possible construction of the tab and in other constructions the tab can take other suitable forms. In yet other constructions, the cap and plug member 10 may omit the tab 24.

While the members 60, 62, 64, 68, 72 illustrated in FIGS. 5a-5e are pipes or tube, the cap and plug member 10 can be used to cap or plug any suitable member. The body portion 14 of the cap and plug member 10 can be used to plug any suitable hollow member having an opening, such as a containers, pipes, tubes, fittings, or any suitable hollow member and the like. The first and second cavities 36 and 36′ can be used to cap any suitable member such as rods, pipes, tubes, fittings, containers, and the like.

In one particular application, the combination cap and plug member 10 can be used to cap or plug openings of an intake manifold used in a vehicle. As is understood by one of skill in the art, intake manifolds for vehicles typically include several openings with a wide range of sizes. After the intake manifold is manufactured, it is often desirable to prevent dirt, dust, and other debris for entering the manifold through the openings. Therefore, the manufacturer of the manifold may desire to inhibit debris from entering the manifold before the manifold is installed in a vehicle by using a cap or plug. The cap and plug member 10 provides a single member that can be used to plug the wide range of opening sizes that exist in a typical vehicle intake manifold. Prior methods of capping or plugging openings of vehicle manifolds utilized a cap or plug specifically sized for one size opening, requiring an inventory of may different caps and plugs.

In addition, the illustrated cap and plug member 10, which is formed from a resilient material, has been found to withstand pressurization of the hollow member that the cap and plug member 10 is used to cap or plug while minimizing the force needed to remove the cap and plug member 10. For example, in one application, the hollow member 72 of FIG. 5e which could represent a portion of a vehicle intake manifold as described above, is pressured using air during a leak test of the hollow member 72, and the cap and plug member 10 substantially prevents the pressurized air from leaking through the opening 70 of the hollow member 72. Substantially preventing pressurized air from leaking through the opening 70 allows the user to detect leaks in the hollow member 72 and components in fluid communication with the hollow member 72. In one construction of the cap and plug member 10, the hollow member 72 can be pressurized up to approximately 70 pounds per square inch and the cap and plug member 10 will remain sealed within or over the opening 70. However, the cap and plug member 10 requires relatively little manual force to remove the cap and plug member 10 from the opening 70.

Various features and advantages of the invention are set forth in the following claims.

What is claimed is:

1. A combination cap and plug member comprising:
a first end;
a second end;
an outer surface portion between the first end and the second end and configured to be received in an opening of a hollow member;
a first tapered cavity including an opening at least partially defined in the first end, the first tapered cavity defining an inner dimension that increases toward the first end, the first tapered cavity configured to receive a member;
a second tapered cavity including an opening at least partially defined in the second end, the second tapered cavity defining an inner dimension that increases toward the second end, the second tapered cavity configured to receive a member.

2. The combination cap and plug member of claim 1, wherein the outer surface portion is tapered.

3. The combination cap and plug member of claim 2, wherein the outer surface portion is generally continuously sloped from the first end substantially to the second end.

4. The combination cap and plug member of claim 3, wherein the outer surface portion is the outermost surface portion of the cap and plug member.

5. The combination cap and plug member of claim 1, wherein the cap and plug member is substantially frustoconical.

6. The combination cap and plug member of claim 1, wherein the cap and plug member defines a central axis that extends longitudinally therethrough, wherein the outer surface portion is tapered with respect to the central axis from the first end substantially to the second end to define a taper angle, and wherein the taper angle ranges from about 0 degrees to about 60 degrees.

7. The combination cap and plug member of claim 6, wherein the taper angle ranges from about 0 degrees to about 40 degrees.

8. The combination cap and plug member of claim 1, wherein the first and second cavities have a non-annular cross section.

9. The combination cap and plug member of claim 1, wherein the first and second cavities each include an innermost end defined by a wall that separates the first and second cavities.

10. The combination cap and plug member of claim 1, wherein the first and second ends of the cap and plug member define a length of the cap and plug member, wherein the first and second cavities each define a cavity length that extends from an innermost portion of the cavity to the opening, and wherein the cavity lengths of the first and second cavities range from about 25 percent to about 75 percent of the length of the cap and plug member.

11. The combination cap and plug member of claim 1, wherein the first and second cavities each include an innermost end, and wherein the first and second cavities are generally continuously tapered from the innermost end to the opening.

12. The combination cap and plug member of claim 1, wherein the cap and plug member is formed from a resilient material.

13. The combination cap and plug member of claim 1, further comprising a tab adjacent one of the first end and the second end.

14. A combination cap and plug member comprising:
a first end;
a second end;
a tapered outermost surface portion that extends from the first end substantially to the second end and is configured to be received in an opening of a hollow member;
a first tapered cavity including an opening at least partially defined in the first end, the first tapered cavity defining an inner dimension that increases toward the first end, the first tapered cavity configured to receive a member;
a second tapered cavity including an opening at least partially defined in the second end, the second tapered cavity defining an inner dimension that increases toward the second end, the second tapered cavity configured to receive a member.

15. The combination cap and plug member of claim 14, wherein the outer surface portion is generally continuously sloped from the first end substantially to the second end.

16. The combination cap and plug member of claim 14, wherein the cap and plug member is substantially frustoconical.

17. The combination cap and plug member of claim 14, wherein the first and second ends of the cap and plug member define a length of the cap and plug member, wherein the first and second cavities each define a cavity length that extends from an innermost portion of the cavity to the opening, and wherein the cavity lengths of the first and second cavities range from about 25 percent to about 75 percent of the length of the cap and plug member.

18. The combination cap and plug member of claim 14, further comprising a tab adjacent one of the first end and the second end.

19. A combination cap and plug member comprising:
a first end;
a second end;
an outer surface portion between the first end and the second end and configured to be received in an opening of a hollow member;
a tapered cavity including an opening at least partially defined in the first end, the tapered cavity defining an inner dimension that increases toward the first end, the tapered cavity configured to receive a member, wherein the tapered cavity defines one of a frustoconical and a conical volume.

20. The combination cap and plug member of claim 19, wherein the tapered cavity is a first tapered cavity, the cap and plug member further comprising a second tapered cavity including an opening at least partially defined in the second end, the second tapered cavity defining an inner dimension that increases toward the second end, the second tapered cavity configured to receive a member, wherein the second tapered cavity defines one of a frustoconical and a conical volume.

21. The combination cap and plug member of claim 19, wherein the outer surface portion is generally continuously sloped from the first end substantially to the second end.

22. The combination cap and plug member of claim 19, wherein the outer surface portion is the outermost surface portion of the cap and plug member.

23. The combination cap and plug member of claim 19, wherein the first and second cavities each include an innermost end defined by a wall that separates the first and second cavities.

24. The combination cap and plug member of claim 19, wherein the first and second ends of the cap and plug member define a length of the cap and plug member, wherein the first cavity defines a cavity length that extends from an innermost portion of the cavity to the opening, and wherein the cavity length ranges from about 25 percent to about 75 percent of the length of the cap and plug member.
